(19) United States
(12) Patent Application Publication
(10) Pub. No.: US 2011/0203708 A1
(43) Pub. Date: Aug. 25, 2011

(54) SHOCK ABSORBING WHEEL

(75) Inventor: Stig-Erik Se-Young Karlsson, Molndal (SE)

(73) Assignee: AGRIA TRADGARDSMASKINER I KALLERED AB, Kallered (SE)

(21) Appl. No.: 13/102,364

(22) Filed: May 6, 2011

Related U.S. Application Data
(63) Continuation of application No. 12/417,155, filed on Apr. 2, 2009, now abandoned.
Application No. 12/417,155 is a continuation of application No. PCT/SE2007/050679, filed on Sep. 27, 2007.

(30) Foreign Application Priority Data
Oct. 4, 2006 (SE) 0602085-3

(51) Int. Cl. B60B 9/02

(52) U.S. Cl. 152/17

(57) ABSTRACT

The present invention relates to a shock absorbing wheel with shock absorbing properties, the wheel comprises a hub, arms and a rim. The hub comprises radial junctions between the arms and the hub, additionally the rim comprises radial junctions between the arms and the rim, wherein between the radial junctions of the hub and the rim the arms are arranged with a substantially sinusoidal shaped form. The arms further comprise a first, a second, a third and a fourth section, wherein in the first section, the arms extend from the radial junctions between the arms and the hub in a first radial direction A, and in the forth section, the arms extend from the radial junctions between the arms and the rim in a second radial direction B. The sinusoidal shaped form is arranged in the second and the third sections of the arms. The present invention is said to provide for a cost effective wheel with good shock absorbing properties.

### TECHNICAL FIELD

The present invention relates to a shock absorbing wheel with shock absorbing properties, the shock absorbing wheel comprises arms with a substantially sinusoidal form.

### BACKGROUND OF THE INVENTION

Shock absorbing wheels with different shapes of the arms of the wheel are known for use with e.g. machines. Wheels are used today in a number of different ways, and in some cases it might be advantageous with shock absorbing wheels, e.g. vehicles, machines and in other devices where shock absorbing wheels are required. There are several shock absorbing wheels on the market. This type of shock absorber has some limitations however concerning the possibility of providing a great length of stroke and resistance to forces larger than the permitted spring force at the same time the spring wheel is rigid with respect to revolving.

A shock absorbing wheel is described in the publication U.S. Pat. No. 1,489,233. The wheel comprises a hub, arms and a rim. The arms can be said to be substantially sinus shaped, however, the wheel described in the publication fails to fully utilize the sinus shaped arms in order to provide shock absorbing properties. Further in U.S. Pat. No. 1,527,122 is a wheel with sinus shaped arms described. However, the hub comprises a relatively complex configuration, without adequate shock absorbing properties.

### SUMMARY OF THE INVENTION

The above mentioned problems are at least partly solved by the present invention. Specifically are they at least partly solved by a shock absorbing wheel comprising arms arranged between a hub and a rim. The hub comprises radial junctions between the arms and the hub, additionally the rim comprises radial junctions between the arms and the rim. Between the radial junctions of the hub and the rim are the arms arranged with a substantially sinusoidal shaped form, although in one embodiment the arms may comprise a curved form. The arms comprises a first, a second, a third and a fourth section, wherein in the first section, the arms extend from the radial junctions between the arms and the hub in a first radial direction, and in the forth section, the arms extend from the radial junctions between the arms and the rim in a second radial direction, and in that the sinusoidal shaped form, alternatively the curved, is arranged in the second and the third sections of the arms. The present invention provides for a cost effective shock absorbing wheel with great length of stroke and which can absorb forces greater that the permitted spring force.

One embodiment of the present invention comprises a shock absorbing wheel comprising sinusoidal shaped arms rotateable around a hub, extended and in cooperation with a rim which is movable in radial and tangential direction. The mentioned sinusoidal shaped arm is the biasing element which is divided into four sections where the arms in the first section has an end attached to a hub and exhibit a disc shaped extension. in the second section the arm continues in a bend which bends away from the rim and that part of the bend that is closest to the rim is the cam of the bend. In the third section the arm continues with an additional bend which is bend from the hub and that part of the bend that is closest to the hub is the cam of the bend. In the forth section the arm continues which has a disc shaped extension and is attached to the rim. The arms disc shaped extensions opposing ends than the attachment points are compliant in the tangential direction and the shortest distance that are between the mentioned ends of the bend are compliant in the longitudinal direction of the distance. The mentioned bends can advantageously be connected so that a sinusoidal form like look is achieved for a greater durability and for a greater spring effect. The space between the rim and the cam in the bend of the second section and also the space between the hub and the cam in the bend of the third section gives the rim a possibility to both radial and tangential movement. Further, the space functions as the shock absorbers length of stroke and even before the spring force of the arm is exceeded, the cam of the bends can be supported against the rim respectively the hub, which protects the arms from a stress which is larger than permitted spring force.

Further is the movement of the hub and the dm, with respect to each other, determined by the space between the radial junction of the sinusoidal like arms of the wheel and the rim and the radial junction of the sinusoidal like arms of the wheel and the hub.

The arms can also be protected by means of round support plates arranged on both sides of the wheel and arranged at the hub and these plates can support the inside of the rim before the permitted spring force is exceeded on the arm. it is also possible to attach additional plates on the above mentioned plates and then with a larger dimension and these can function as cover plates to prevent dirt and similar from intrusion.

In an embodiment on the present invention is the sinusoidal shaped form in the second and third sections substantially aligned with a radius curvature which runs parallel with the rim so that the sinusoidal shaped form is provided along the radius curvature. The embodiment fully utilizes the function of the sinusoidal arms and the arms different junction positions for shock absorbing properties. Further, the embodiment secures that the arms are only exposed to a minimum of contact surfaces if the shock absorbing wheel is imparted with a force exceeding the spring force of the arms. The sinusoidal shaped arms in the second and the third sections may form a full sinusoidal wave between the first and the forth section of the arms. Preferably, the first and the forth sections may be equally long. The second and the third sections may be substantially equally long as measured along the radius curvature. It is believed that the symmetric arrangement of the arms of the wheel provides not only a balanced wheel but homogenous force absorption. In one embodiment of the present invention, the hub, arms and rim are manufactured in one piece of material. This enables fast and cost effective production of shock absorbing wheels. However, it is within the boundaries of the present invention that the arms are separate parts with respect to each other. This may be beneficial from maintenance and repair point of view.

The shock absorbing wheel may further comprise at least one support disc arranged to the hub and/or the rim so as to provide for a deformation stop to the arms, preferably at least two support discs, more preferably circular support discs. in cases of two supports disc, the support discs may be attached to the hub and the rim respectively. The support disc solves a number of different problems, some problems which are solved are; Protection against external negative forces subjected to the shock absorbing wheel. Supporting the rigidity of the shock absorbing wheel in a direction transverse of the rotational direction. More specifically in can be mentioned that the support disc attached to the rim provides for an increased rigidity of the rim, especially in those areas along the rim which are between the arms of the shock absorbing wheel. A support disc attached to the rim can further decrease the wear, e.g. from a support disc attached to the hub, or possibly from the cam of the bends as described above. A support disc attached to the rim is specifically beneficial for increasing the rigidity of the relevant part of the shock absorbing wheel. Additional benefits are that the manufacturing tolerance of the shock absorbing wheel can be lowered due to the support discs. As a consequence, a high manufacturing rate can be prioritized.

A shock absorbing wheel according to the present invention is preferably used in vehicles or machines. Examples of vehicles are cars, trucks, lorries, lift trucks, such as fork-lift trucks, roller skates, skate boards, cycles, motorcycles, boats, airplanes, space crafts or the like. Example of machines are conveyer bands, production equipment, typewriters, part of rolls, engines, fans, such as ventilation fans, pumps, or the like. Areas or products to which the present invention is useful are further gardening devices, such as lawn mowers, preferably motor driven lawn mowers, suitcases, trolleys such as shopping trolleys, toys, such as toy vehicles, carriages or the like. However, other fields of use are possible within the boundaries of the present Invention.

It is to be noted that the embodiments comprising the curved arms, as an alternative to the sinusoidal shaped arms, may comprise all the different features as described in combination with the sinusoidal shaped arms and be used in all the above mentioned areas or in all the above mentioned products or applications.

### BRIEF DESCRIPTION OF THE DRAWINGS

The invention will be described in the following by way of example only and with reference to the attached drawings, in which;

FIG. 1 shows a view in perspective of a sinusoidal shaped arm of a wheel divided into four sections;

FIG. 2 shows a view in perspective of a shock absorbing wheel system with sinusoidal shaped arms;

FIG. 3 shows a second embodiment of the present invention in perspective;

FIG. 4 shows the second embodiment of the present invention equipped with a tyre;

FIG. 5-6 shows an arm for use with a wheel according to the present invention;

FIG. 7 shows a plurality of arms for use with a wheel according to the present invention;

FIG. 8 shows a shock absorbing wheel according to the present invention in an exploded view in perspective.

### DETAILED DESCRIPTION OF PREFERRED EMBODIMENTS

The invention will now be described for exemplifying purpose in greater detail with the aid of embodiments and with reference to the attached drawings. According to one embodiment of the present invention, FIG. 1 shows an arm with a sinusoidal shaped extension according to the present invention, the arms extended 5 part which is in a first section and one end attached to a hub and further into a second section which comprises a bend 6 which bends away from the rim 4 so that a space between the rim 4 and the cam of the bend. Further in the third section, a bend 7 that bends away from the hub 2 that also leaves a space between the cam of the bend 7 and the hub 2. The second sections bend 6 is connected to the bend 7 of the third section and arranged so that a sinusoidal shaped wave is provided. Further in the fourth section, an extended 8 part which makes the arm 3 second end and attached into the rim 4. To manufacture the wheel, for example, different types of plastics may be used which advantageously may be extruded or molded.

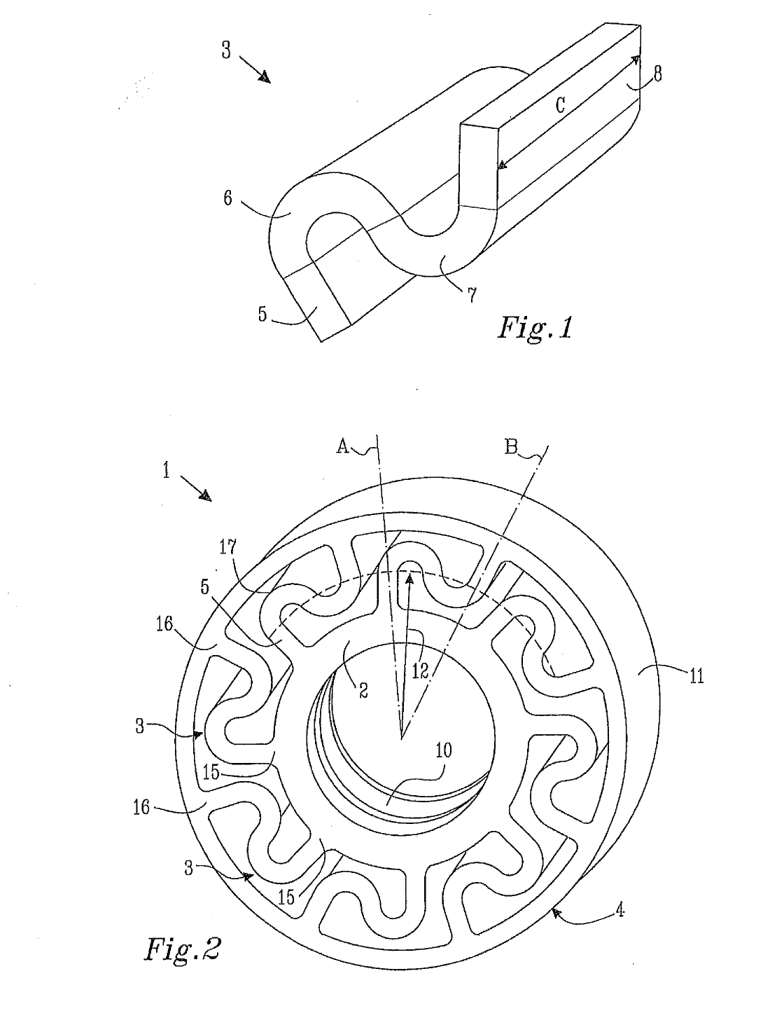

As seen in FIG. 2, the shock absorbing wheel 1 comprises at least a first radial direction A and a second radial direction B. The shock absorbing wheel 1 further comprises an inner periphery 10 and an outer periphery 11, substantially between the inner and the outer periphery 10, 11 is a middle radius 12, which can form a radius curvature around the hub 2 and parallel with the rim 4. The middle radius 12 is a virtual radius running at a certain distance from the center of the shock absorbing wheel 1 as illustrated in the FIG. 2. The hub 2 comprises radial junctions 15 between said arms 3 and the hub 2, additionally the rim 4 comprises radial junctions 16 between the arms 3 and the rim 4.

As mentioned earlier, the arms 3 each comprises a first, a second, a third and a forth section, corresponding to the extended part 5, the two bends 6, 7 and the following extended part 8. The arms 3 extended part 5 extends in the first section from the radial junction 15 between the arm and the hub 2 along the first radial direction A in a substantially straight line, and thereafter transcends to the sinusoidal shaped form 17 after reaching the middle radius 12. The sinusoidal shaped form 17 of the arm 3 extends substantially parallel with the inner and outer periphery 10, 11, along the middle radius 12 following the radius curvature formed thereby, through the second and third section. The arms 3 thereafter transcends back into a straight section, i.e. the forth section, which extends along the second radial direction B. As can be seen in FIG. 2, the first radial direction A is displaced with respect to the second radial direction B. The displacement is determined by the length of the sinusoidal shaped part 17 of the arms 3.

The shock absorbing wheel 1 may comprise, as shown in FIG. 2, eight arms which provide the chock absorbing properties to the shock absorbing wheel 1. In different embodiments of the present invention, two or more arms are present in the shock absorbing wheel, preferably 3-20, more preferably 0-10 arms, most preferred 4-8 arms.

As mentioned, the shock absorbing wheel may be extruded or molded. It is preferably manufactured in one piece of material. in this case, the hub, the arm including all four sections, and the rim are formed integrally. This is very advantageous since it permits the shock absorbing wheel to be manufactured in a cost efficient manner while still providing a strong, rigid shock absorbing wheel.

Suitable material for a shock absorbing wheel according to the present invention comprises, among others, thermoplastic material such as polystyrene, polypropylene, polyethylene (e.g. HDPE or LDPE), PVC, polyurethane, polyesters, polyetherimide, polyphenylene oxide, semi-crystalline polymeric materials such as polyetheretherketone or acetal copolymer, mixtures thereof, or the like. Other suitable materials are metals, such as aluminum, steel, copper, iron, alloys comprising copper, iron or nickel, combinations thereof, or the like.

After manufacture, the shock absorbing wheel 1 is advantageously assembled with bearings, such as ball bearings, inside the hub, and an assembly axis onto which the ball bearings and the shock absorbing wheel 1 is permitted to freely rotate, and which can be assembled further with vehicles, machines, in-lines, carriages, trucks or other equipment as mentioned earlier which might need a shock absorbing wheel according to the present invention. Along the rim 4 is preferably a polymer composition attached so as to form a smooth or pattern wearing surface dependent on the intended use for the shock absorbing wheel 1.

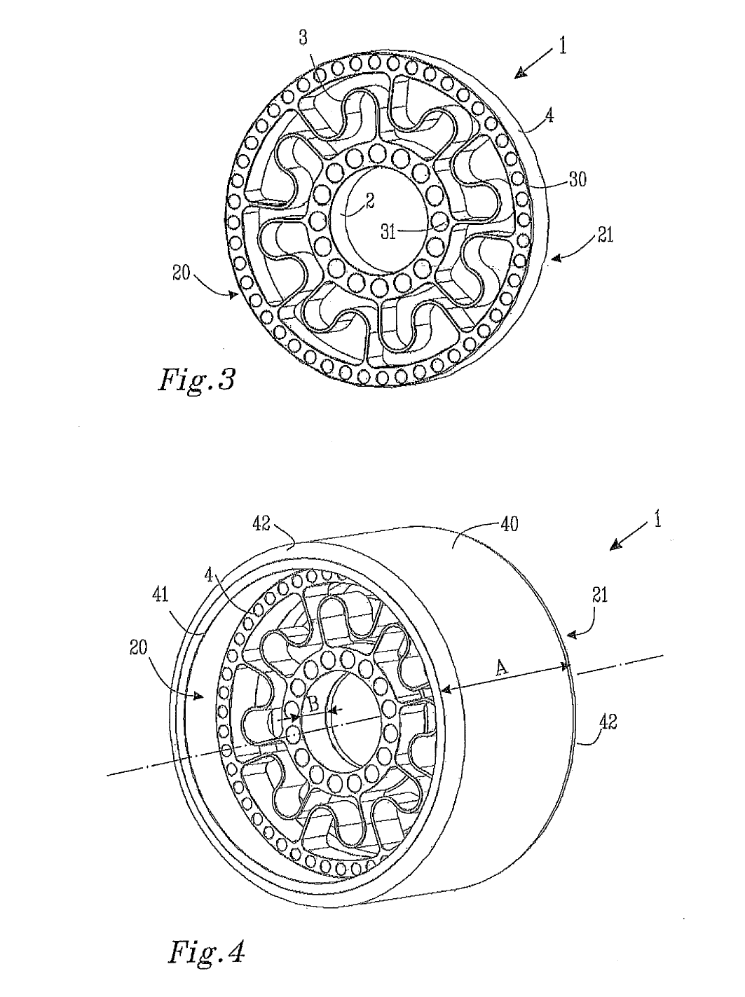

FIG. 3 shows another embodiment of the present invention. FIG. 3 shows a shock absorbing wheel 1 comprising a hub 2 and a rim 4. The shock absorbing wheel 1 comprises a first and a second side 20, 21. Between the hub 2 and the rim 4 are arms 3 arranged. Each arm 3 comprises a first, a second, a third and a forth section, corresponding to the extended part 5, the two bends 6, 7 and the following extended part 8, and extends in the same way as the arms 3 described with reference to FIG. 2.

Additionally, the embodiment of the present invention shown in FIG. 3 comprises a plurality of rim holes 30 and a plurality of hub holes 31. The rim holes 30 are arranged in the periphery of the rim 4 and serve the purpose of enabling attachment of the wheel to e.g. at least one support disc, another shock absorbing wheel 1, or other suitable accessory. Further the rim holes 30 serves to provide the rim 4 with certain flexibility, which further emphasize the shock absorbing properties of the wheel 1. Additionally the rim and the hub holes 30, 31 save material during production of the shock absorbing wheel 1 and reduces the weight of the shock absorbing wheel 1. The rim holes 30 are through holes in the shown embodiment of the present invention, i.e. they extend from the first side 20 to the second side 21 of the shock absorbing wheel 1. The holes can however extend partly through the rim 4. In those case were the rim holes 30 extends partly through the rim 4, the rim 4 may or may not be arranged with such rim holes on both the first and the second side 20, 21 of the shock absorbing wheel 1.

The hub 2 may further be arranged with hub holes 31. The hub holes 31 are through holes in the shown embodiment of the present invention, i.e. they extend from the first side 20 to the second side 21 of the shock absorbing wheel 1. The hub holes 31 can however extend partly through the hub 2, as the rim holes 30. In those case were the hub holes 31 extends partly through the hub 2, the hub 2 may or may not be arranged with such hub holes on both the first and the second side 20, 21 of the shock absorbing wheel 1.

One embodiment of the present invention may comprise only hub holes 31 on the first side 20 and only rim 30 holes on the second side 22, e.g. partly through hub holes 31 on the first side 20 of the shock absorbing wheel 1, while an the second side 21 of the shock absorbing wheel 1 comprise only partly through rim holes 30, or vice verse.

FIG. 4 shows the shock absorbing wheel 1 from FIG. 3 but additionally comprising a tyre 40 which is arranged around the periphery of the rim 4. Between the tyre 40 and the rim 4 is a support rim 41 arranged. The tyre 40 comprises a width A adjacent to the support rim 41. The width A of the lyre 40 is slightly decreasing further away from the support rim 41 so that an angle 42 is created between the tyre 40 and the support rim 41 at the first and the second side 20, 21 of the shock absorbing wheel 1. The angle 42 may of course in other embodiments of the present invention exhibit a curved form. The support rim 41 also exhibits the width A. The tyre 40 may be an inflatable tyre, solid tyre, or any other type of tyre appropriate for the specific purpose.

The hub 2 of the shock absorbing wheel 1 comprises a width B. The width B can be about 0.3-30 cm, preferably 1-15 cm. Preferably the width A>13.

The arms of the shock absorbing wheel according to the present invention may further exhibit a width C, for clarity reasons indicated by the reference C in FIG. 1 and FIG. 5. The Width B and the width C are preferably equal.

FIG. 5 shows an arm 50 for use in a wheel according to the present invention. The arm 50 comprises a rim junction part 51 for connection to a rim. The arm 50 also comprise a first, a second, a third and a forth section 52, 53, 54, 55 corresponding to the extended part 5, the two bends 6, 7, and the extended part 8, as shown in FIG. 1. The arm 50 further comprises a hub junction part 56 for connection to a hub. The arm 50 exhibits the same width C along the arms extension, i.e. along the rim junction part 51, the first, second, third and forth section 52, 53, 54, 55, and the hub junction part 56.

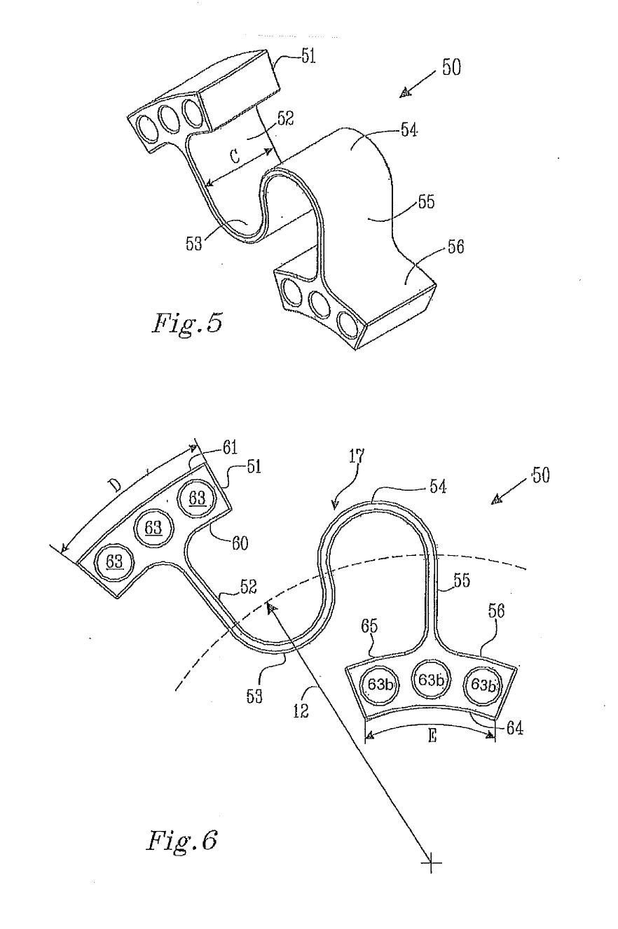

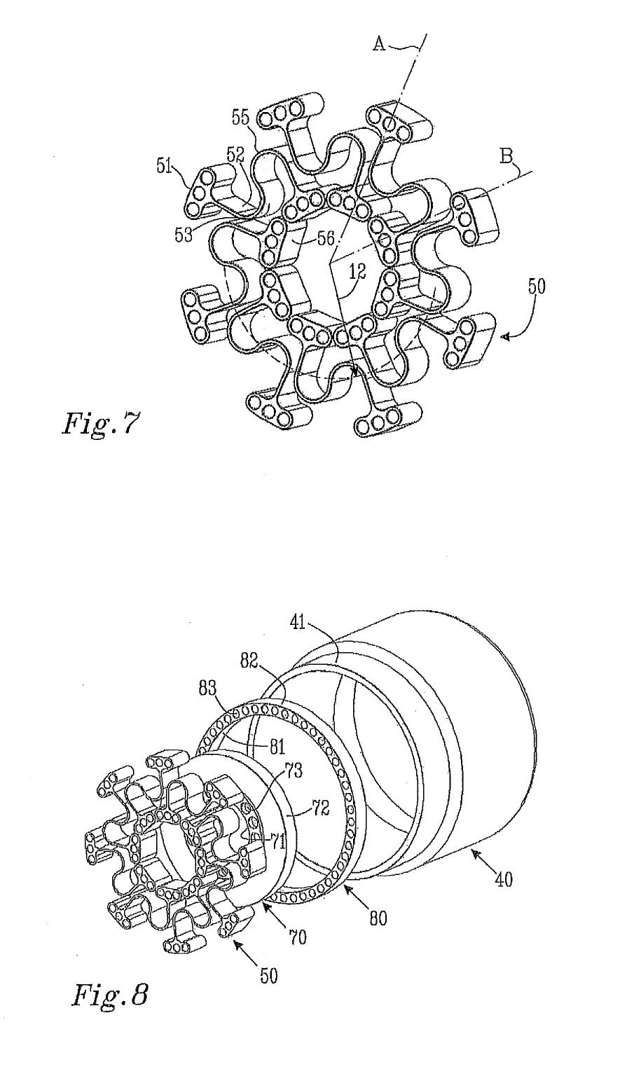

FIG. 6 shows the arm 50 as seen from the side. The rim junction part 51 comprises an inner and an outer surface 60, 61. The rim junction part 51 comprises a radial extension D along which the arm 50 can be connected to a rim or a rim support disc which form a rim, as will be described with reference to FIG. 7. The rim junction part further comprises a plurality of rim holes 63, which may be through rim holes or partly through rim holes or combinations thereof, as described earlier with reference to FIGS. 3 and 4. The arm 50 further comprises, as mentioned, a hub junction part 56 with an inner and an outer surface 64, 65. The hub junction part 56 comprises a radial extension E along which the arm 50 can be connected to a hub or a hub support disc which form a hub. The radial extension D of the rim junction part 51 comprise a radial curvature along the outer surface 61, while the radial extension E of the hub junction part 56 comprises a radial curvature along the inner surface 64. Despite the radial curvature, the rim junction part 51 and the hub Junction part 56 can each respectively be said to form a substantially T-shaped connection part. The radial extension D and E provides for a firm and secure fixation of the arm 50 to a rim and to a hub.

FIG. 7 shows a plurality of the arms 50, more specifically 8 arms 50 arranged in a wheel like formation. A wheel comprising arms 50 according to the present invention may preferably comprise 3-20 arms, more preferably 3-10 arms, most preferably 4-8 arms. The first section 51 of the arm 50 extends from the rim Junction part 51 along a first radial direction A in a substantially straight line, and thereafter transcends to the sinusoidal shaped form 17 after reaching the middle radius 12. The sinusoidal shaped form 17 of the arm 50 extends substantially parallel with the inner surface 60 of the rim junction part 51, and along the middle radius 12 following the radius curvature formed thereby, through the second and third section. The arm 50 thereafter transcends back into a straight section, I.e. the forth section 55, which extends along the second radial direction B into the hub junction part 56. As can be seen in FIG. 8, the first radial direction A is displaced with respect to the second radial direction B. The displacement is determined by the length of the sinusoidal shaped part 17 of the arm 50.

FIG. 8 shows a shock absorbing wheel 100 according to the present invention in an exploded view. The shock absorbing wheel 100 comprises separate arms 50 in a wheel like formation, a circular hub support disc 70, a circular rim support disc 80, a support rim 41 and a tyre 40. The circular hub support disc 70 comprises an inner radius 71 defining a hole, and an outer radius 72, defining an outer surface. A plurality of connection holes 73 are arranged around the inner radius 71 for connection with the hub Junction parts 56 of the arms 50 so that a hub is formed. The circular rim support disc 80 comprises an inner radius 81 defining a hole, and an outer radius 82, defining an outer surface. A plurality of connection holes 83 are arranged between the inner radius 81 and the outer radius 82 for connection with the rim junction parts 51 of the arms 50 so that a rim is formed. The mentioned support discs will during use of the shock absorbing wheel provide for a deformation stop to the arms 50 if the wheel 100 is subjected to a force high enough. They will also provide for the advantages as described above.

In the same manner may a shock absorbing wheel manufactured in one piece of material, as described above, also include at least one hub support disc, attached to the hub, or a rim support disc, attached to the rim, and preferably both, so as to provide for a deformation stop to the shock absorbing wheel.

1. A shock absorbing wheel comprising arms arranged between a hub and a rim, said hub comprises radial junctions between said arms and said hub, additionally said rim comprises radial junctions between said arms and said rim, wherein between said radial junctions of said hub and said rim said arms are arranged with a substantially sinusoidal shaped form wherein said arms comprises a first, a second, a third and a fourth section, wherein in said first section, said arms extend from said radial junctions between said arms and said hub in a first radial direction, and in said fourth section, said arms extend from said radial junctions between said arms and said rim in a second radial direction, and in that the sinusoidal shaped form is arranged in said second and said third sections of said arms, said first radial direction, said difference being different from said second radial direction determined by the length of said sinusoidal shaped form, wherein said first and second radial directions only intersect one single arm.

2. The shock absorbing wheel according to claim 1, wherein said sinusoidal shaped form in said second and third sections are substantially aligned with a radius curvature which runs parallel with said rim so that said sinusoidal shaped form is provided along said radius curvature.

3. The shock absorbing wheel according to claim 2, wherein said sinusoidal shaped arms in said second and said third sections form a full sinusoidal wave form between said first and said forth section of said arms.

4. The shock absorbing wheel according to claim 1, wherein said first and said forth sections are substantially equally long.

5. The shock absorbing wheel according to claim 1, wherein said second and said third sections are substantially equally long.

6. The shock absorbing wheel according to claim 1, wherein hub, arms and rim are manufactured in one piece of material.

7. The shock absorbing wheel according to claim 1, wherein said arms are separate parts with respect to each other.

8. The shock absorbing wheel according to claim 1, wherein said shock absorbing wheel further comprises at least one support disc arranged to the hub or the rim so as to provide for a deformation stop to said arms.

9. The shock absorbing wheel according to claim 8, wherein said shock absorbing wheel comprises two support discs.

10. The shock absorbing wheel according to claim 1, wherein said shock absorbing wheel is for use in vehicles and machines.

11. The shock absorbing wheel according to claim 1, wherein said shock absorbing wheel is for use with suitcases.

12. The shock absorbing wheel according to claim 1, wherein said shock absorbing wheel is for use with roller-skates.

13. The shock absorbing wheel according to claim 1, wherein said shock absorbing wheel is for use with lift trucks.

14-17. (canceled)
